(19) United States
(12) Patent Application Publication
(10) Pub. No.: US 2019/0047639 A1
(43) Pub. Date: Feb. 14, 2019

(54) Retractable Air Flow Panels

(71) Applicant: Robert A. Deligiannis, Lawrenceville, GA (US)

(72) Inventor: Robert A. Deligiannis, Lawrenceville, GA (US)

(21) Appl. No.: 14/696,454

(22) Filed: Jul. 18, 2017

(51) Int. Cl. B62D 35/00; B62D 37/02; B62D 33/08; B62D 25/02

(52) U.S. Cl. CPC B62D 35/001; B62D 25/02; B62D 33/08; B62D 37/02

(57) ABSTRACT

For years, the trucking industry has been trying to eliminate the large gap between the tractor and trailer causing greater crosswinds and drag. This decreases the aerodynamics, causing greater fuel consumption and less stability with the tractor and trailer.

The Retractable Air Flow Panel system increases the aerodynamics by eliminating 90-95% of the gap between the tractor and trailer, causing much less crosswinds and drag. The results are greater fuel savings and safety. The RAFP is made of aluminum and fiberglass panels attached to the frame of the tractor. They are specific to the make and model of the tractor and the trailer and are customized to close the 90-95% gap. The RAFP is mounted on structural aluminum plats behind the tractor. The RAFP is attached to the relay controller which are connected to the speedometer on the tractor. When the tractor-trailer reaches a speed of 55 mph, the relay controller connected to the speedometer sends a signal to the electric motors, thus the RAFP opens automatically. Similarly, when the tractor-trailer decreases to a speed of 50 mph, the relay controller sends the signal to close the RAFP.

### BRIEF SUMMARY OF THE INVENTION

Retractable air flow panels (RAFP) reducing aerodynamic drag between tractor and trailer, thus increasing fuel efficiency and safety for the driver of the truck.

### BACKGROUND OF THE INVENTION

The current systems have a large space between the tractor and trailer causing greater crosswinds and drag. This decreases the aerodynamics and causes greater fuel consumption and less stability with the tractor and trailer. The RAFP's increase the aerodynamics by eliminating 95% of better of the space between the tractor and trailer, causing much less crosswind and drag. The results are greater fuel savings and safety.

### BRIEF DESCRIPTION OF THE SEVERAL VIEWS OF THE DRAWINGS

FIG. 1: #1 trailer, #2 tractor, #3 the gap between tractor & trailer, #4 cab extender and #5 frame of the tractor.

FIG. 1a: Top view of #1 trailer, #2 tractor, #3 gap between tractor and trailer, #4 cab extender and #5 frame of tractor

FIG. 2: Open position of the Retractable Air Flow Panels (RAFP). #1 Trailer, #2 tractor, #4 cab extender, #5 frame of tractor, #6 neoprene rubber end, #7 (RAFP) panels, #8 mounting support for the (RAFP), #9 entire structural aluminum support of the (RAFP) and #13 electric motor hinge stanchions to open and close the (RAFP) automatically.

FIG. 2a: Top view of the (RAFP) open position. #1 Trailer, #2 tractor, #4 cab extender, #5 frame of tractor, #6 neoprene rubber end, #7 (RAFP) panels, #8 mounting support for the (RAFP), #9 entire structural aluminum support of the (RAFP), and #13 electric motor hinge stanchions to open and close the (RAFP) automatically.

FIG. 3: The (RAFP) closed position. #1 trailer, #2 tractor, #3 gap between tractor and trailer, #4 cab extender, #5 tractor frame, #9 the structural aluminum base support for the (RAFP).

FIG. 3b: Top view (RAFP) closed. #1 trailer, #2 tractor, #3 gap between tractor and trailer, #4 cab extender, #5 frame of tractor, #6 neoprene rubber end, #7 the (RAFP) panel, # ft mounting support for the (RAP)), #9 structural aluminum base of the (RAFP) and #13 electric motor hinge stanchions to open and close the (RAFP) automatically.

FIG. 4: The Cross section of the (RAFP). # S frame of the tractor, #8 neoprene rubber end (RAFP). #7 panel that closes the gap between the tractor and trailer, #8 mounting support for the (RAFP), #9 structural aluminum of the (RAFP), #11 electric rotor hinge stanchions to open and close the (RAFP), #14 electric motors that operate from a bad relay controller located in the #2 tractor, when the speed of the tractor-trailer reaches 55 MPH, the (RAFP) will automatically open. When the speed of the tractor-trailer drops below 50 MPH, the (RAFP) will automatically close. The tractor-trailer does not have any maneuvering problems operating on the highway or in town. #15 houses the electric motors.

FIG. 5: Top view of the (RAFP) open. #6 the neoprene rubber ends, #7 the panels, #8 the mounting support of the (RAFP) and #9 is the structural aluminum base.

FIG. 5a: Top view of the (RAFP) closed. #6 the neoprene rubber ends, #7 the panels, #8 the mounting supports of the (RAFP) and #9 is the structural aluminum base.

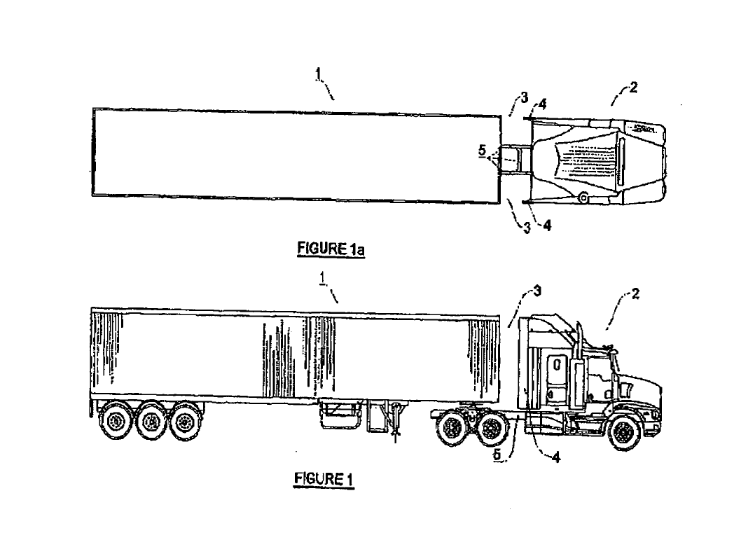

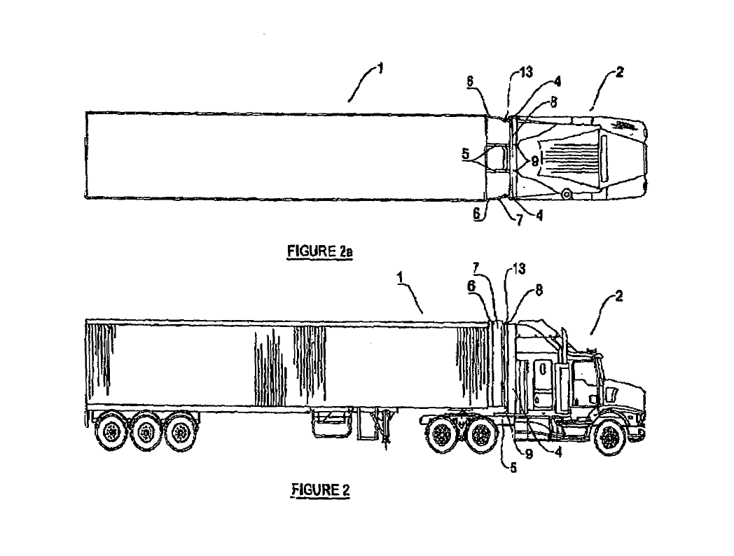

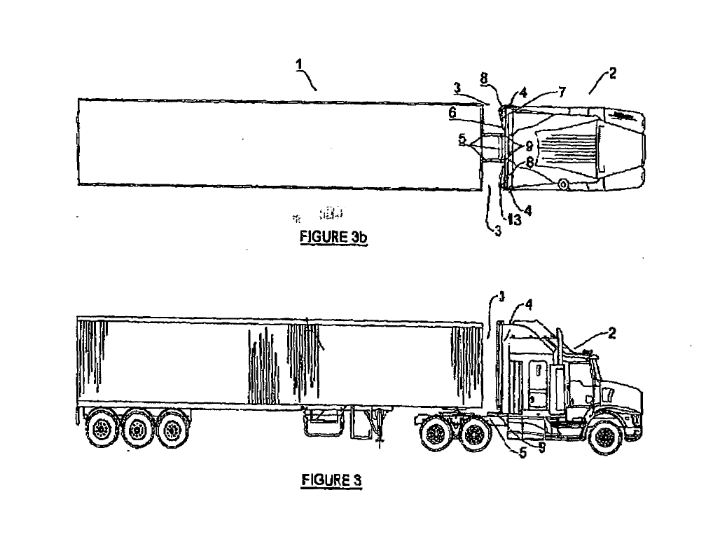

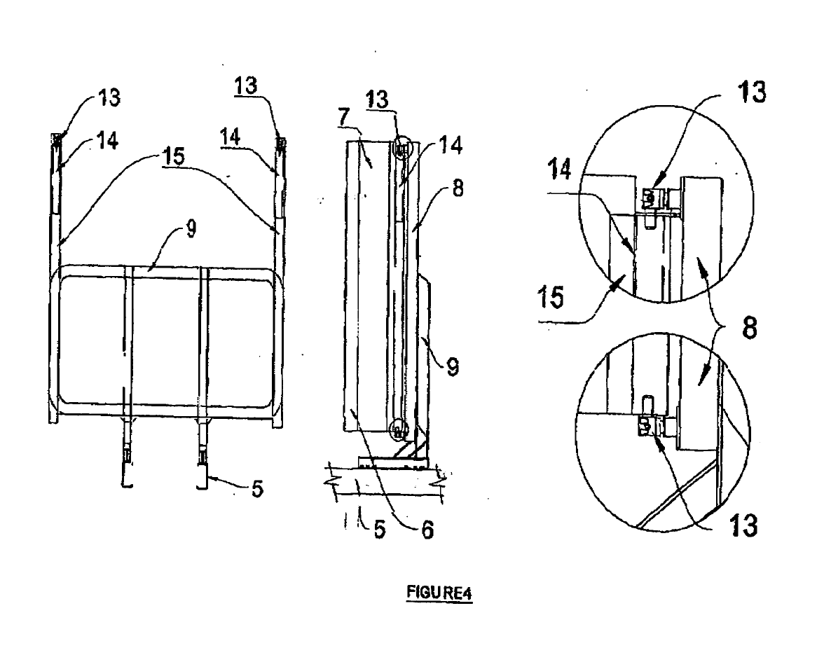

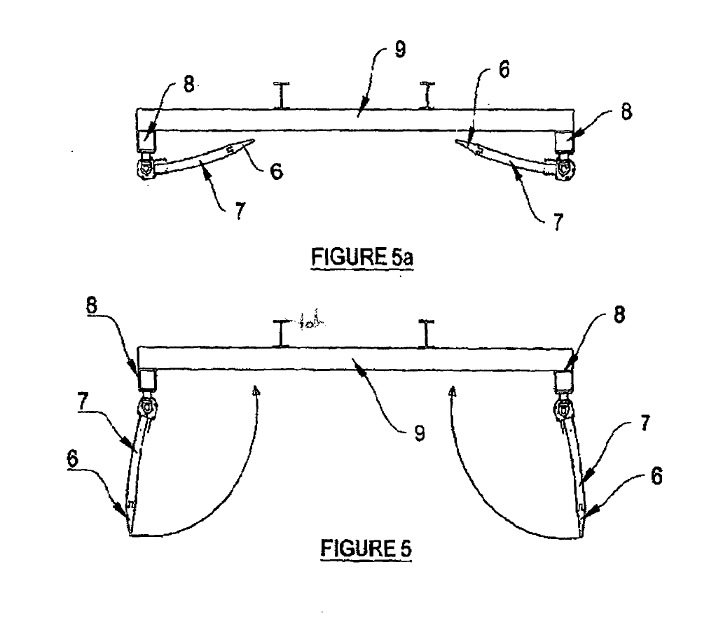

### DETAILED DESCRIPTION OF THE INVENTION

Panels are light weight made of fiber glass, magnesium or aluminum with rubber trim.

Hinges (piano hinges, pin hinges, butt hinges) any of those hinges will support the RAFP's.

A truck cab guard is bolted to the frame of the truck chassis. The cab guards would be anywhere from 86 to 110 inches high and 86 to 96 inches wide, depending on the truck.

Air cylinders, hydraulic cylinders or electric servo motors are used to pen and close the RAFP's. If hydraulic cylinders are used, a hydraulic pump, reservoir would be needed. Air cylinders would use the air compressor, which the truck is equipped with. The RAFP's are controlled by electrical sensors wired to the electrical speedometer. When the truck reaches a speed of 25 miles per hour the RAFP's will open. When the speed drops below 25 mph, the RAFP's will close.

1: Significantly decreases the turbulent air flow between the tractor and trailer.

2: Decreases the gap between the tractor and trailer.

3: Does not interfere with turning radius and maneuverability.

4: Reduces aerodynamic drag between the tractor and trailer.

5: 6-13% fuel savings depending on the configuration of the tractor and trailer.
